(19) United States
(12) Patent Application Publication
(10) Pub. No.: US 2008/0155654 A1
(43) Pub. Date: Jun. 26, 2008

(54) Method And Device For Re-Dispatching Specifically Coded Access Objects From A Server To A Mobile Terminal Device

(76) Inventors: Andree Ross, Luedinghausen (DE); Dirk Frijters, Bochum (DE); Dirk Gaschler, Wermelskirchen (DE)

Correspondence Address: Hollingsworth & Funk, 8009 34th Avenue South, Suite 125, Minneapolis, MN, 55425, US

(21) Appl. No.: 11/791,199

(22) PCT Filed: Dec. 3, 2004
(86) PCT No.: PCT/IB2004/003975

§ 371 Date: Jan. 25, 2008

(51) Int. Cl. H04L 9/32

(52) U.S. Cl. 726/2

(57) ABSTRACT

The present invention relates to the field of protected data using specifically coded access objects on mobile terminal devices and specifically to a method end a server for enabling a user to re obtain a SCAO of a mobile terminal device that has been lost. The method of the invention provides a possibility for re-dispatching a SCAO from a server to a terminal device via a receiving at a server at least one terminal device identification and/or authentication data and determining if said identification and/or authentication data identifies a terminal identification as being related to a terminal for which an initial specifically coded access object has previously been generated. The method is continued by obtaining at said server a secondary specifically coded access object according to a received terminal identification if a received terminal identification has been identified as a terminal for which an initial specifically coded access object has previously been generated. The method may be terminated by sending said secondary specifically coded access object to said terminal device 15 via said network, said terminal device having a terminal device identification said secondary specifically coded access object has been obtained for.

The invention generally relates to the field of protected data using specifically coded access objects (SCAOs) on mobile terminal devices. More particularly the present invention relates to a method for enabling a user to re-obtain a SCAO of a mobile terminal device, which SCAO has been lost.

The use of SCAOs is required to enable a content provider to control the access to digital objects such as digital contents or e.g. software programs. Conventionally this is achieved by one or more SCAOs that are required to use content (as e.g. music, a video or a game) in the terminal device. Conventionally, specifically coded digital access objects are transferred only once from a specifically coded digital access object server to said terminal device. The SCAOs will become necessary to avoid the use of memory modules such as known e.g. from Gameboy™ and N-Gage gaming devices. These coded solid state embodiments can easily be provided with sufficient copy protection to avoid unpermitted copying. However, the main drawback of these conventional hard-coded memory modules resides in the necessary sales infrastructure. At present it is possible to buy N-Gage game modules only in certain shops. The use of modules significantly increases the costs for a single game, because of storekeeping and retailer surcharges.

Thus it is desirable to circumvent the conventional storekeeping for hardware modules by storing just a number of bits and sending a certain bit sequence directly to a user via an electronic interface and a Wide Area Network (WAN). This solution, however, implies that the received universally applicable program may be copied in large numbers, which may significantly reduce the profits of the manufacturers of such electronic applications.

The use of digital copy protection also known as digital rights management (DRM) leads to the use of coded digital access objects that restrict the use of specific software to a specific device. To receive such a coded digital access object a user has to pay the provider, whereupon the whole distribution chain is reduced to a single digital transmission from a provider to a terminal of a user. When using customarily coded programs or key-sequences a certain content can only be read or executed by a single terminal device.

In case a data error occurs in the terminal or a new firmware is required it may happen that the specifically coded digital access objects get lost in whatever way.

Conventionally a user of a terminal device has no possibility to once again request the transfer of a received specifically coded digital access object from the provider without extra payment. Further, this is excluded, as the issuer conventionally not permanently stores the specifically coded digital access object together with a device identification. Once specifically coded digital access objects are downloaded they can be stored on a user storage media but cannot be stored online under protection of the rights issuer. Especially when using a DRM system with multiple coded digital access objects this storage on the server side leads to significantly increasing consumption of storage resources.

At present due to the use of memory devices it is possible for a user to backup said coded digital access object on a storage medium or e.g. on a computer device connected via a local hardwired, a local infrared or a short range radio connection. At present it is envisaged to use one or more specifically coded access objects (SCAOs) to execute the content (such as music, video, game, software . . . ) in a terminal device.

The fact that a user has to pay for a specifically coded access object (SCAO) indicates that precautions should be taken to prevent that these SCAOs may get lost, or that users may want to “migrate” SCAOs to another device. That is, it is desirable to reduce all possible restrictions a user may experience when using SCAOs on a terminal device.

It is desirable to prevent that any kind of event deleting stored SCAOs results in loss of the ability to execute a specific content. It is also desirable to prevent that a user loses the ability to execute a specific content when a device a SCAO is provided for gets damaged. It is especially desirable to provide a method and a device to enable a user to still execute a content with a SCAO even if the device said SCAO has been generated for is not longer available.

According to a first aspect of the present invention a method for re-dispatching a SCAO from a server to a terminal device via a communication network is provided. The method comprises receiving at a server at least one terminal device identification and/or authentication data (e.g. via said communication network) and determining if said identification and/or authentication data identifies a terminal identification as being related to a terminal for which an initial specifically coded access object (SCAO) has previously been generated.

The method further comprises obtaining at said server a secondary SCAO according to a received device identification and authentication data if a terminal identification has identified said terminal as a terminal for which an initial SCAO has previously been generated and sending said secondary SCAO to said terminal device via said cellular communication network, said terminal device having a terminal device identification said secondary SCAO has been obtained for.

By receiving at a server at least one terminal device identification and/or authentication data the server may access respective data that have previously been stored in connection with these data. It is envisaged that the server receives a terminal device identification of a single device or terminal device identifications of two or more different devices. In a simple embodiment only a single terminal identification is received representing e.g. a device address necessary for the following step of re-transmitting the SCAO. The terminal device identification can be used for statistics applications to ascertain the usefulness of the method. In an embodiment not directly relying on the terminal device identification the authentication data can be used to obtain the SCAO(s) of a user. The terminal device identification may not be essential in case of a simple re-transmission of said SCAO to a terminal, but it may be helpful to avoid collisions in case of “double entries” of usernames and passwords or in case of accidentally “highjacked” login name/password pairs.

The authentication data may e.g. comprise a username and a password like known from state of the art authorization or authentication procedures.

It may be possible to economize the authentication data, if the respective SCAO can be accessed by a device identification received. In this case the device identification would be sufficient to obtain said SCAO by recalling a previously generated SCAO that has been stored on the server, filed under the device identification to enable the server to retrieve said SCAO.

Said terminal device identification can e.g. be in case of a mobile or cellular device an International Mobile Equipment Identification (IMED, a Subscriber Identity Member (SIM) Code, a device related public key, a unique device key, a telephone number or the like. It is also possible to implement device identification as a software code in the firmware of said terminal device. The use of a device identification in the software code in the firmware has the advantage that it is possible to update or change the device identification.

By determining if said identification and/or authentication data identifies a terminal identification as being related to a terminal for which an initial specifically coded access object (SCAO) has previously been generated it is assured that the user (or terminal) requesting said re-issuance or re-dispatching or the re-transmission of a SCAO has a kind of authorization or justification to access e.g. the database of the server. In the following the expression “initial SCAO” is used for an access object that is received at said server, that has been stored in said server or that has previously been generated at the server, i.e. a SCAO that is not generated in the context of the present method. The expression secondary SCAO is used to refer to SCAO that has been retrieved or generated during the method of the present invention and that is to be sent to a terminal device via said communication network.

Following the verification of the identification and/or authentication data the server obtains a secondary SCAO according to a received device identification and authentication data. This is only performed if a terminal identification has identified said terminal as a terminal for which an initial SCAO has previously been generated. The usage or execution of contents (such as games, music or video files) on a terminal requires the presence of at least one SCAO in the device. This SCAO may be served as a digital rights management (DRM) object. The SCAO may be coded according to a public key of said terminal device. The execution of content may be performed by a decoding process of said specifically public key coded access object with a private key of said terminal device.

It is to be noted that the verified identification and/or authentication data can be related to the same or to another device said server obtains said secondary SCAO for. That is, in one case said obtained secondary SCAO is substantially identical to said initial SCAO. In case of only one received device identification it is sufficient to simply retrieve said initial SCAO (or a copy of said SCAO) as the secondary SCAO, if the initial SCAO has been stored previously. The online backup of a SCAO can be stored on a server while said device is still intact and the backup can be stored together with at least a terminal device identification and additional data on a secure server.

It is also envisaged to receive two different device identifications. When using two different devices, one terminal identification can be used to indicate that a user or a device has already achieved/acquired a SCAO and wants to use the feature of this access object also on another terminal with a second terminal identification. In this case the user requests the issuance of a second(ary) SCAO that is specifically coded according to the identification of said second terminal. This implementation represents a kind of “factory provided copy of a SCAO out of good will”. In this case the SCAO provider has no possibility to ensure that there are no copies of the “initial SCAO” left, that is this service is a “two for the price of one” service. Only when the device said initial specifically coded access object (SCAO) has been generated for has been destroyed it is ensured that no secondary or double use of a SCAO may occur. However the number of accidents wherein a terminal device actually perishes (and the device identification is still available) is negligible compared to the number of the exchanged or newly purchased of terminal devices. The server can receive the terminal identification of two different devices and an authentication to “copy” or “transfer” said digital coded access object from one terminal device to another terminal device.

Finally said obtained secondary SCAO is sent to said terminal device with the terminal device identification said secondary SCAO has been obtained for.

In any case the secondary SCAO is sent to the terminal device the SCAO has been generated for. The present invention strives to send a secondary SCAO as a replacement for a lost one or as a possibility to execute or use a certain content on another terminal device if a user loses the possibility to execute or use this content, because the initial terminal is not longer available.

With the present invention a user has no longer to rely on a single terminal for executing a certain content, the user has no longer to take care for backing-up the SCAOs. Additionally, a user may also be enabled to use e.g. different terminals for executing a content using different SCAOs provided by a provider. It is to be noted that it is envisaged to include a SCAO that is coded in accordance with a SIM-number and in accordance with a certain device identification. This use of a double SCAOs can significantly simplify any authentication and authorization procedures if e.g. the SIM-card identification or the device identification is sufficient to request a new SCAO. In this scenario a user may change the terminal or the SIM-card without losing the possibility to execute a certain content.

In an example embodiment said method further comprises storing said initial SCAO in a preceding step at said server. In this embodiment it is not essential how the server obtains said initial SCAO. It is for example envisaged that the server acquires said initial SCAO from another (e.g. a DRM) server, indirectly from an access server or directly from terminals. By storing said initial SCAO in a preceding step it is assured that the server already has a (or all) initial SCAO(s) available. The server serves as a kind of initial SCAO backup server. By storing initial SCAOs any necessity for a user to provide a decentralized backup becomes unnecessary. That is, this implementation simplifies the use of initial SCAOs on terminal devices, by providing a kind of information recovery service. This embodiment discloses a mechanism to backup the online requested specifically coded access object (SCAO) in the premises of the issuer of the SCAO.

In an example embodiment said initial SCAO is stored after an initial generation of said initial SCAO. That is, e.g. a digital rights management server stores a copy of each generated and allocated SCAO directly transferred to a user terminal in a database of said server or e.g. in a special (external) backup server. This embodiment represents the straightforward approach by collecting all available initial SCAOs when they are generated. By collecting and storing all generated initial SCAOs it can be assured that each user having lost his initial SCAO for any reason can easily and quickly recover his initial SCAO. The server represents a kind of universal initial (or secondary) SCAOs database. It may be envisaged to store the SCAO in a secure server in an un-coded form as an un-coded access object. The backup of the un-coded access object can enable the backup server to provide a SCAO coded according to the data of another terminal device.

In another example embodiment of the present invention said initial SCAO is stored after a reception of said initial SCAO from a terminal device during an online access. This approach represents a kind of “ex-post” initial (or secondary) SCAO collector striving to collect all initial SCAOs that become accessible e.g. by a game server or the like. Especially it is envisaged to collect initial and secondary SCAOs. This may help to implement a broad database with the available SCAOs and respective user identification (username and password) device identifications (e.g. IMEI) or subscriber identifications (SIM-card codes). In case of a broad database the access to the database may be restricted to prevent that code principles become derivable from the database by applying a correlation analysis. The restriction to the database may be implemented by a restriction to the number of accessible initial SCAOs per time period (e.g. 10 per day).

This may be achieved by an online application that requires for its execution one of the SCAOs. The provider of the online application can e.g. provide an access to an online application after a login procedure. The login procedure may comprise username and password and may in case of a mobile cellular terminal device be comprised of an identification of an additional IMEI (International Mobile Equipment Identification via GPRS access). The access procedure or the login procedure may support a rights object acquisition protocol (ROAP) to get access to said SCAOs for acquisition. The backup server may automatically store the (with the unique device key) encrypted SCAOs in an online download. The terminal device requires specific keys for acquisition and decryption of SCAOs, which may be embodied as a private/public key pair for authentication and asymmetric en- and decryption. The terminal may also support a right object acquisition protocol.

The backup server may connect to an online server providing an online access application for terminal devices via a communication network. A user can connect his device to the server using username, password, IMEI. The User downloads a specifically coded access object (SCAO) from the server (this download may be a complex procedure which however is not important for the backup procedure itself). Download of SCAOs requires mutual authentication. SCAOs are encrypted prior to download. Encryption takes place with the aid of the unique terminal device related public key.

A copy of the encrypted and downloaded SCAOs or even a notice of the download of the SCAOs is transferred to the backup server. The backup server does administrate all SCAOs of the user of the terminal device. Each user (or terminal) is clearly defined by username, password, IMEI or even by the unique public device key itself. The server may check the validity of the received SCAOs. Since each SCAO is stored encrypted on the backup server there is no need for additional security barriers.

Once a user of a terminal wants to download a backup of his SCAOs the user has to login to the backup server and be granted access to his backup account by checking username, password, IMEI or even the unique public device key.

The backup method can be implemented as an automatic backup procedure during online download of obtained SCAOs (using an assignment on the basis of e.g. username, password, IMEI). The backup method can be implemented as a user interactive backup. In this case the user has to login into the online server and must forward his encrypted SCAOs to his online backup server (using, e.g. username, password, IMEI).

Said initial SCAO may be received after the server has sent a request for transmitting said initial request to a connected terminal. That is, it is envisaged to implement a request from the server to a terminal device to hand over the initial SCAOs stored on said terminal device together with an identification of the terminal and/or the user/subscriber.

In yet another example embodiment said step of obtaining at said server said secondary SCAO is performed by retrieving said previously stored initial SCAO. That is, said secondary SCAO is identical to said initial SCAO. This scenario represents a kind of server provided backup copy or backup recovery procedure for terminal devices.

The specifically coded access objects (SCAOs) stored in said server are specifically encrypted with e.g. the unique mobile identification or device key. For this reason the SCAOs can only be used on a single device. This specificity may enable the operator of the server to allow unrestricted access to all database contents, as only these terminals may use the SCAO as the backups can only be used by a dedicated device due to encryption. Once a device gets broken the backups are unusable because they cannot be used by a swapped device because the new device will have a different set of device identification with different unique private/public keys for encryption and decryption. The SCAOs of the broken device do not match with the SCAOs of the new device.

This embodiment discloses a solution to enable a user to recover a (lost or deleted) SCAO of the device. This is achieved by a mechanism to backup the online requested SCAO under the protection of the issuer of this SCAO.

In another example embodiment of the present invention two terminal device identifications are received, i.e. a first device identification and a second device identification. In this case of two different received device identifications said step of obtaining at said server a SCAO is performed by decoding said previously stored initial SCAO according to said first received device identification and generating said secondary SCAO according to said second received device identification. Said secondary SCAO is coded for transmission to said device with the second received device identification.

This implementation represents an extension of the remote backup server to a scenario to enable a user to “transfer” an initial SCAO from a first terminal to a second device with a second device identification. This is achieved according to this example embodiment by the reception of a first device identification and a second device identification (and eventually authorization data). The first device identification is used to determine a previously stored initial SCAO. This SCAO is then decoded according to said first device identification to obtain an un-coded or universal access object. This obtained un-coded access object may serve as a basis for an unlimited number of SCAOs, thus the server has to be thoroughly protected against undesired data access. The obtained un-coded access object is used to generate the secondary SCAO that is coded according to the device identification of the second device. That is, the user presents the device identification of the first device and the device identification of the second device to request a new secondary SCAO for a second device. In this embodiment, the initial SCAO is retrieved from the server according to the identification data of the first device.

According to another example embodiment of the method of the present invention two terminal device identifications, a first device identification and a second device identification are received at said server via said communication network. In this embodiment further an initial specifically coded access object (SCAO) is received at said server via said communication network, wherein said SCAO is coded according to said first device identification. In this embodiment said step of obtaining at said server said secondary SCAO is performed by decoding said received initial SCAO according to said first received device identification and generating said secondary SCAO for transmission according to said second received device identification.

This embodiment of the method can be performed without any necessity to have previously stored initial SCAOs. This feature may also be interpreted as providing a possibility to allow a user to “copy” the digital coded access object a few times e.g. 2, 3 or 5 times to enable e.g. a kind of “controlled” or slightly restricted copy protection. This can e.g. enable a user of a certain content on a first terminal device to execute the content with a new SCAO on a second terminal device. It may also be envisaged to implement a “universal” coded access object not requiring a specifically coded device identification for granting a universal access to said contents without any restrictions. However the implementation of a universal access code has the inherent thread that to become public before it is desired to give up the restrictions on the execution of said contents requiring said SCAO for execution.

This embodiment is provided to save SCAOs of users. The SCAOs may be stored globally at an online repository (backup server) and/or at premises of a user. The backup server can be accessed by the user via online access while the private backups can be stored on a local PC, MMC or any other storage media. The stored SCAOs are used as a backup and are encrypted. The backup is needed if the SCAO inside the device is corrupted or the device is broken, i.e. the private backup gets inaccessible.

The unique private decryption key for each terminal and a unique public encryption key are required for the terminal device have to be stored globally inside a central server. These private and public keys can be implemented by the private terminal device key and a unique public device key. The encryption method can be standardized. The certificate type can e.g. be X.509. The central server is a global database accessible from different sites and must be kept secret or at least very strongly protected. Furthermore the private and public keys have to be forwarded and labeled or hard-coded into terminal devices during production. The user is able to create own backup of SCAOs in user owned premises. The backup is encrypted with the unique public terminal device key. The security requirements of the central server are very high. The access to the central server must neither be possible by any hacker nor by any unauthorized person.

It may be implemented to employ a service point with a link to the backup server and to the central server. These links can be used to download the specifically coded access objects (SCAOs) of a dedicated user and to update the online account & repository (backup server) of the user in case of a swap of a terminal device.

The central server stores the important data of each produced terminal device (at least of a single terminal device manufacturer). The data file of each terminal device stored on the central server can contain the unique private terminal device key, the unique public device key (e.g. as signed terminal certificate), an identifier of the public keys (e.g. certification identifier serial no. of X.509) and maybe other X.509 parameters, and a unique terminal device identification (e.g. IMEI).

The complete data file of a specific terminal device can definitely be identified by one of the above shown items of the data file.

The following data items of each terminal device specific data files stored on the central server are provided by the manufacturer or have to be requested from the manufacturer of the terminal devices, i.e. the unique private terminal device key and the unique public device key and additional coding parameters (such as e.g. a key identifier e.g. serial no. of X.509 and other X.509 parameters).

The manufacturer of the terminal device has to provide the central server with the unique terminal device identity (e.g. the IMEI).

According to another aspect of the present invention a method for re-dispatching a SCAO from a server to a terminal device in a system comprising a terminal and a server connected via a communication network is provided. Said method comprises sending from said terminal device at least one terminal device identification and/or authentication data to said server (e.g. via said communication network) and receiving at said server said at least one terminal device identification and said authentication data. The method proceeds with determining if said identification or authentication identifies a received terminal identification as being related to a terminal for which an initial SCAO has previously been generated. The method further comprises obtaining at said server a secondary SCAO according to a received device identification and authentication data, if a received terminal identification has identified a terminal for which an initial specifically coded access object (SCAO) has previously been generated. The method further comprises sending said secondary SCAO to said terminal device via said communication network, said terminal device having the terminal device identification said secondary SCAO has been obtained for, and receiving and storing said secondary SCAO in said terminal device.

By sending at least one terminal device identification and/or authentication data from said terminal device to said server (e.g. via said communication network) a user of a terminal device can provide an identification and an authorization to a server to access data (e.g. a SCAO) stored on said server. In a previous step this transmission may also be used to transfer an already existing (initial) SCAO (e.g. as the authentication data) to said server in a kind of external backup procedure. Following said previous transmission the server may store the received (initial) SCAO functioning as an external backup storage. It may also be envisaged that the server receives said initial SCAOs from e.g. a digital rights server in a preceding step. It is also contemplated that the server actively searches for devices in said communication network for retrieving (initial) SCAOs from devices in said communication network. It is also envisaged to employ game servers such of e.g. online games played via said communication network to retrieve pairs of terminal identifications and SCAOs for storage in said server. The stored pairs of terminal identifications and SCAOs enable a simple re-acquirement of lost SCAOs.

The at least one terminal device identification and authentication data, which have been sent, are received at said server. Subsequently to reception it is determined at the server if said identification/authentication identifies a received terminal identification as being related to a terminal for which an initial SCAO has previously been generated or stored. If it has been determined that for one of said received terminal identifications an initial SCAO has previously been generated a user can be enabled to (re-) obtain a SCAO.

When an initial SCAO has previously been generated for a terminal device with identification as received a secondary SCAO is obtained at the server. Said secondary specific access object can be identical to a previously stored initial access object, or can be specifically generated according to a received terminal device identification. In case that only a single terminal identification is received it is expected that the initial SCAO is retrieved and sent to the terminal as the secondary SCAO. In case that the received terminal identification data identifies two different terminal devices it is expected that the first device identification (e.g. together with an initial SCAO) provides a proof of an access authorization. In this case said secondary specifically coded access object (SCAO) can be generated for the terminal with the second device identification, i.e. the secondary SCAO is different to said initial SCAO. In this embodiment said secondary generated access object may be generated following a “decoding” of said initial coded access object (according to the identification of the first device) and a re-coding of said decoded initial SCAO to said secondary SCAO.

It ought to be noted that if the original universal (i.e. un-specifically/un-coded) access object is available at the server the un-coding of said initial SCAO may be economized. It is also contemplated to apply an “inverted un-coding process” to check the authenticity of said received initial SCAO. An “inverted un-coding process” would comprise coding said universal access object according to said identification of said first device and comparing said received initial SCAO with said newly generated SCAO. This is especially applicable if e.g. an asymmetrical coding algorithm is applied wherein it requires much more efforts to decode an initial SCAO than to code another SCAO from the universal access code.

By sending said obtained secondary SCAO via said communication network to said terminal device with the terminal device identification said secondary SCAO has been obtained for the secondary SCAO is delivered to said terminal or to the user to enable an execution or the usage of content.

By receiving and storing said secondary SCAO in said terminal device the user can execute or use said contents. It is also possible that the user may store said received secondary SCAO in a backup storage to prevent that the user has to use said service again for example in case of a memory or software failure of said terminal device.

In another example embodiment said method further comprises storing said initial SCAO on a user memory device operatively connected to said terminal device.

This feature represents a personal backup procedure of said initial SCAO. This backup can also be used to reload the initial SCAO in case of a memory failure or an unintended deletion of said initial SCAO in said terminal device. This feature is useful in case that said terminal gets damaged and the initial SCAO may be used as a proof for the purchase of said SCAO.

In another example embodiment said method further comprises storing an identification of said terminal together with said initial specifically coded access object (SCAO) on said user memory device. This example embodiment can enable a user to simplify the access to a secondary SCAO in case of a destruction of a terminal device. This is especially useful if e.g. the terminal device identification of a first terminal device is not accessible, because the device and/or an additional device identification (as may be provided in the manual of the first terminal) are lost. The storage space required for storing said identification data on said terminal is compared to the actually available storage elements very low.

In still another example embodiment of the present invention said communication network is a cellular communication network and said terminal device is a mobile cellular terminal of said cellular communication network. That is the present invention may be related to a system for providing computer programs for terminal devices such as e.g. mobile phones or mobile phone enabled communicators. The present invention can also be used to deliver SCAO to video game enabled cellular telephones.

According to yet another aspect of the invention a software tool is provided comprising program code means for carrying out a method of the preceding description when said program product is run on a computer or a network device.

According to another aspect of the present invention a computer program product downloadable from a server for carrying out a method of the preceding description is provided, which comprises program code means for performing all of the steps of the preceding methods when said program is run on a computer or a network device.

According to yet another aspect of the invention a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer or a network device.

According to another example embodiment of the present invention a network server connected to a communication network is provided for re-dispatching a SCAO from said server to a terminal device via said communication network. Said network server comprises an interface to said communication network, an authentication means, a secondary SCAO obtaining means and at least one storage.

Said interface to a communication network is provided for receiving at least one terminal device identification, an initial SCAOs and authentication data. That is, said interface is provided for receiving data from a terminal device that that actually cannot access a certain content because of a missing specifically coded access object (SCAO). Said interface is also provided to send a newly generated secondary access object to said requesting device. Said interface is also configured to send obtained secondary SCAOs via said communication network to terminal devices for which secondary SCAOs has been obtained for.

Said authentication means is connected to said interface and is provided for authenticating received terminal device identification and/or authentication data. Said authentication means is configured to determine if said identification or authentication, identifies a terminal identification as being related to a terminal for which an initial SCAO has previously been generated or issued. The authentication may be based e.g. on a certain identification of a terminal device and/or on a certain public terminal device key and an initial SCAO. It is also contemplated to employ a vendor authentication by a settlement of the provider of the SCAOs. In this case an employee may serve as the authentication authority for obtaining a secondary SCAO.

Said secondary SCAO obtaining means is connected to said authentication means and is configured for obtaining secondary SCAOs according to a received device identification and authentication data, in case of positive authentication of said received data by said authentication means. The obtaining means may obtain a secondary SCAO by retrieving respective initial SCAO according to a device identification, according to a user identification or according to a public terminal key. The obtaining means may obtain a secondary SCAO by decoding a received initial SCAO and a received device identification (or e.g. a specific public terminal key).

Said at least one storage connected is connected to said authentication means to be able to check received authentication data and received device identities. The storage can also be provided to store a number of different obtained secondary SCAOs. The storage can also be provided to store a number of different initial SCAOs for retrieving. It is also envisaged to implement a storage for storing accountancy data to obtain statistical data required for evaluating if the provided service is actually accepted and required.

In still another example embodiment of the present invention said communication network is a cellular communication network. That is, the network server is a server of a cellular communication network, said interface is an interface to said cellular communication network configured for receiving at least one terminal device identification of a mobile cellular terminal device. That is, the present invention may be related to a server configured for providing SCAOs for computer programs for mobile cellular terminal devices such as e.g. mobile phones or mobile phone enabled communicators. The present invention can also be used to deliver SCAO to video game enabled cellular telephones.

In the following the invention will be described in detail by referring to the enclosed drawings in which:

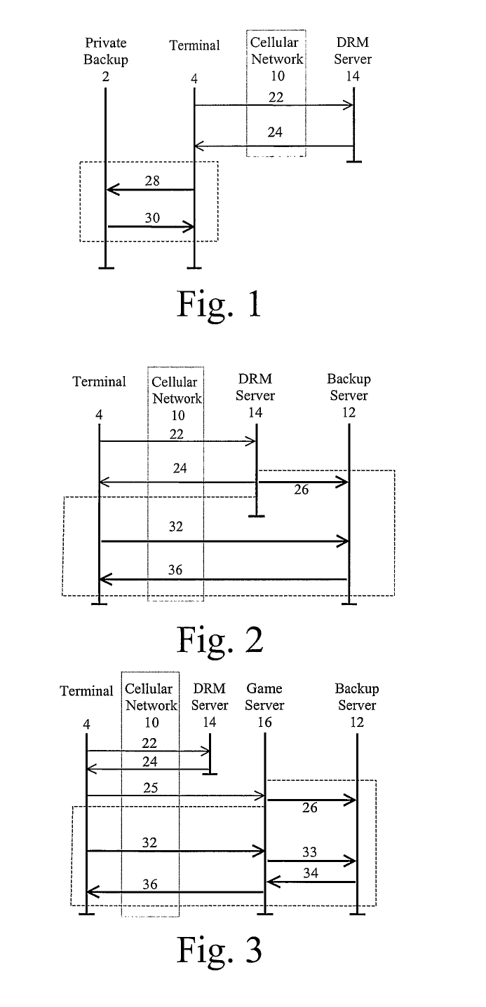

FIG. 1 is a flowchart of a conventional state of the art issuance procedure for a specifically coded access object (SCAO) and an implementation of a backup,

FIG. 2 is an example of a re-issuance procedure of a SCAO in connection with an embodiment of the present invention,

FIG. 3 shows another example of a re-issuance of a SCAO in connection with another embodiment of the present invention,

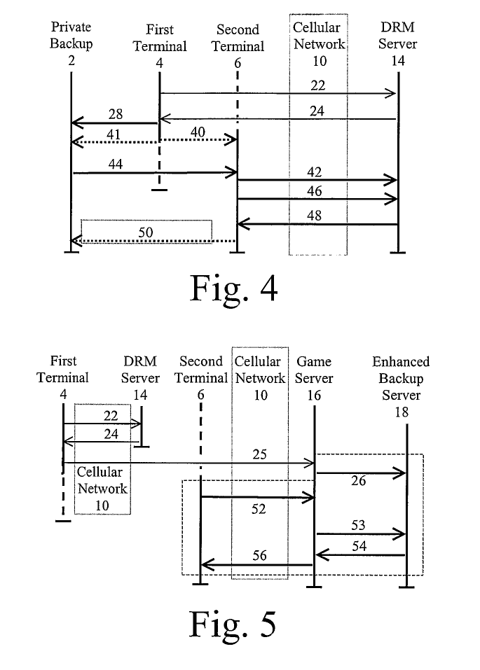

FIG. 4 depicts an embodiment of the present invention for transcribing an initial SCAO to another terminal device,

FIG. 5 displays an embodiment of the present invention of a combined re-issuance and transcription procedure of a SCAO,

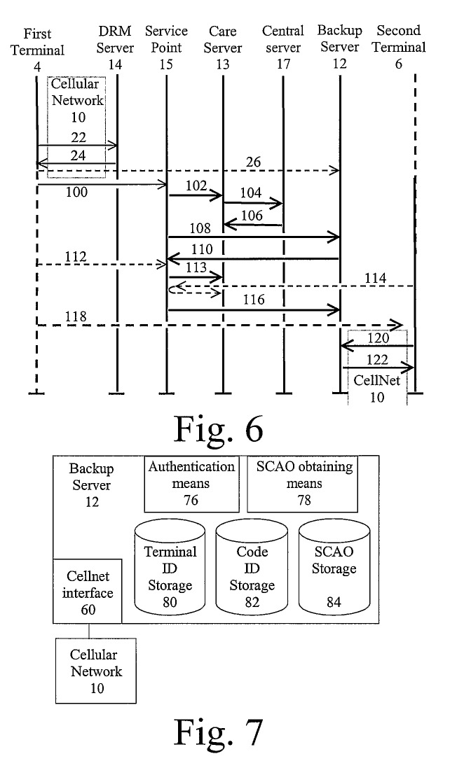

FIG. 6 depicts another implementation of a method to re-issue SCAOs to another terminal device, and

FIG. 7 shows one embodiment of a network server for reissuing and/or transcribing of SCAOs.

In the detailed description that follows, identical components have been given the same reference numerals, regardless of whether they are shown in different embodiments of the present invention. In order to clearly and concisely illustrate the present invention the drawings may not necessarily be to scale and certain features may be shown in somewhat schematic form.

FIG. 1 is a flowchart of a conventional state of the art issuance or dispatching procedure for a SCAO and a generation of private backup of the SCAO. The background of the invention resides in a method to provide the ability to execute or use certain contents on a terminal device such as a mobile cellular terminal device without the need to use memory modules as e.g. known from CD players, small mobile electronic gaming devices and the like. This is achieved according to the state of the art by the use of SCAOs. The SCAOs can be delivered via a communication network such as a cellular communication network. In the figures the terminal device is embodied as a mobile cellular terminal device and said a communication network is embodied as a cellular communication network with out limiting the scope of the claims.

The expression “specifically” refers to the fact that the specifically coded access object (SCAO) allows only the execution or usage of certain contents on a specifically identified terminal. The expression “coded” refers to the necessity to code said SCAO to prevent that a user may copy or adapt a SCAO to any terminal device, circumventing the execution protection provided by the SCAO. The expression “access” in SCAO refers to the task of said SCAO to grant access or the possibility to execute or use a certain content on a cellular terminal device. Finally the expression “object” of SCAO refers to the basically not restricted form of the SCAO. The object can be a part of an executable program, the object may also be a key component necessary to execute, play or use certain files. It is also contemplated to employ a specific content de-scrambling code. It may be envisaged to provide access to a certain type of files or filename. It may be contemplated to employ a combined content and device specific code for granting access to a certain content on a certain terminal. It is possible to employ a fixed private/public key pair for generating said SCAO, wherein said private key may be hardwired in said terminal device, and said “public key” may be only accessible by the generators of said SCAO. In case of an asymmetric coding procedure the public key may be published to all software developers.

In a standard SCAO approach a user requests by a transmission 22 from his terminal device 4 via said cellular network 10 to the Digital Rights Management (DRM) server 14 the issuance of a SCAO.

In the following the DRM server 14 generates a SCAO and transmits 24 said generated SCAO via said cellular network to said terminal 4. The process may employ different additional transmissions including e.g. information about a payment process, additional device specific information, such as device identification, the transmission of a public terminal key to the DRM server 14, payment data and the like. These additional transmissions may comprise a number of transmissions that exchange data between e.g. the terminal, a provider of the communication network 10, different payment centers and the DRM server 14.

At present it is not possible for a user to back up a received SCAO. However it may be possible e.g. in case of an interchangeable memory device with a respective content that the SCAO is also stored on said memory device.

It is expected that users have to pay a considerable amount of money to receive said SCAO to access e.g. a complex terminal device game. In case of a software error, a malfunction of the terminal device or the destruction if the terminal it may happen that the SCAOs may get lost, representing an inconvenience to the user.

Even in case that the specifically coded access object (SCAO) is stored on e.g. an interchangeable memory module this will not contribute to enable an execution of contents on a mobile terminal, as the specificity of the SCAO prevents that this content is executed on another terminal device.

At present there is no option for a user to store a SCAO on an arbitrary backup medium. However in case of complex and extensive contents a way to store many different programs requires the use of interchangeable memory modules (although not provided with hard-coded programs).

FIG. 2 is an example of a re-issuance procedure of a SCAO in connection with an embodiment of the present invention. The initial steps 22 and 24 of requesting and delivering a SCAO from a DRM server 14 via the cellular network 10 are identical to the ones of FIG. 1. The user connects with his terminal device 4 to the DRM server 14 using an identification, e.g. a username, a password, a public device key and/or an IMEI. The DRM server 14 generates a SCAO according to said received device identification. The coding or the generation of the SCAOs is complex but is not important for the backup procedure itself. The download of the SCAOs requires mutual authentication. The SCAOs are encrypted prior to download. Encryption may be implemented by using e.g. a unique terminal device related public key.

Additionally, the DRM server transfers 26 the SCAO or a copy of the SCAOs to a backup server 12. That is, a copy of each generated SCAO is provided to said backup server 12 together with an identification of the terminal said SCAO has been generated for. The SCAOs are stored at the backup server precautionary together with an identification of the terminal said SCAO has been generated for. In case that the SCAO or the terminal 4 gets not lost or does not get damaged, the following steps would not occur. It may be implemented to provide a data overflow or an “aging algorithm” to delete the stored data after e.g. a time period of e.g. 20 years when it can be expected that the last terminal of a certain series has got out of commission. The backup server does administrate all SCAOs of the terminal device or the user of the user of the terminal device. Each user (or terminal device) is clearly defined by username, password, IMEI or even with the unique public device key. The server (backup server) checks the validity of the received SCAOs.

The main merit of the embodiment resides in the fact that a user may re-obtain a SCAO the user already had obtained. Especially the use of SCAOs does not open up new possibilities to users to copy software at will, as the data stored at the backup server 12 is actually coded and can not be used on any other terminal device than the one said specifically coded access object (SCAO) has been generated for. Thus the backup server 12 cannot provide any possibility to circumvent the copy protection provided by the DRM server 14. There is no need for additional security barriers in the backup server as each SCAO is stored encrypted on the backup server.

In case said SCAO gets deleted on said terminal 4, a request 32 for a re-transmission of said SCAO from said backup server 12 to said terminal 4 is dispatched. As the backup server stores a huge amount of different SCAO coded for a huge amount of different terminals, said request 32 has to comprise a terminal identification to enable the server to find the suitable SCAO. It may also be envisaged to also transmit an identification of the contents that requires said SCAO for execution in the request 32. The server 12 can determine the desired SCAO and can re-transmit or re-issue 36 the SCAO to the terminal device 4 via said cellular communication network.

Once a user of the terminal wants to download a backup of his SCAO the user has to login to the backup server and be granted access to his backup account by checking username, password, IMEI or even the unique public device key.

FIG. 3 shows another example of a re-issuance of a SCAO in connection with another embodiment of the present invention.

The initial steps 22,24 of obtaining a SCAO at a terminal device 4 from a DRM server 14 via a cellular communication network 10 are similar to the procedures of FIGS. 1 and 2. In contrast to the FIGS. 1 and 2 the backup server 12 is not directly connected to the terminal device.

In FIG. 3 the SCAO and a device identification (e.g. a username, a password and/or an IMEI) are transmitted from the terminal device 4 to an access server embodied in FIG. 3 as the game server 16. This transmission may be implemented to prove that the identified terminal device can participate in e.g. in an online game, as being capable of executing respective game software.

In contrast to the conventional approach the game server 16 sends 26 a copy of the received SCAO to the backup server 12 together with the received device identification. As in FIG. 2 the backup server 12 stores the SCAO together with said device identification.

The basic elements of FIGS. 2 and 3 are very similar, with the difference that the backup server 12 receives the SCAO via the cellular communication network 10 and via the game server 16 from the terminal 4. Additionally, the terminal 4 communicates indirectly with the backup server 12 via the game server 16 via the transmissions 33,34. The connection between the game server 16 and the backup server 12 may be implemented via direct wired connection or by another communication network. It is contemplated to provide a direct connection between the terminal device 4 and the backup server 12 via said cellular network as depicted in FIG. 2.

FIG. 4 depicts an embodiment of the present invention for transcribing an initial SCAO to another terminal device. The initial steps of acquiring a SCAO are the same as disclosed in the FIGS. 1 to 3. In FIG. 4 a backup of the SCAO is stored in a memory device 2 of a first terminal 4 e.g. in form of a private backup. It is expected that the user want to execute or use a certain content on another terminal device the user has obtained. Due to the specificity of the SCAO this is not possible (e.g. because the devices have different private keys for decoding said SCAO).

In the present scenario the user transfers the SCAO from the first terminal to the second terminal directly 40. The user may also use an interchangeable memory device “private backup” 2 to transfer, 44 the SCAO from the first terminal to the second terminal (e.g. by interchanging a “private backup” 2 module).

It is also envisaged to implement a transfer of the device identification from the first device to the second terminal directly 40, or to transfer 41,44 the device identification of the first terminal device to the second device via the “private backup” 2 module. Transferring e.g. the IMEI of the first device to the second device may do this.

In a next step the second terminal transfers 42 the device identification of the second device and transfers 46 the device identification of the first device and the initial SCAO (coded specifically for the first device) to a DRM server 14 via said cellular communication network 10. In FIG. 4 it is expected that the DRM server 14 can access the un-coded access object or is at least capable of decoding the initial SCAO received from the first device. It is also envisaged that the DRM server 14 can access the stored data of the first device (e.g. on the basis of IMEI of the first device). The DRM server 14 can decrypt the received initial SCAO according to the data of the first terminal 4 from retrieved from the DRM server 14. This step requires that the DRM server 14 can access all data required for decrypting (or encrypting) a SCAO of the first terminal 4. This capability of decoding a SCAO implies that this data has to be protected against unauthorized access. Using the private device key of the first device may do this decryption of the initial SCAO. The un-coded access object can subsequently be re-coded to a secondary specifically coded access object (SCAO) that is specifically coded according the data of the second terminal device 6. Using the public device key of the second device can do the generation of the secondary SCAO. This step is not critical, as the private device key of the second device is not required.

Finally the newly generated secondary SCAO will be sent 48 to the second terminal 6 via the cellular communication network 10. The received secondary SCAO may be transferred from the second terminal device 6 to the interchangeable memory device “private backup” 2.

This represents a kind of secondary SCAO transfer from a first terminal device 4 to a second terminal device 6.

If the content for which the secondary SCAO is required is installed in the second terminal 6 the second terminal 6 can execute or use this content.

It is envisaged to assure that the contents can no longer be executed on the first device. This may be achieved by ensuring that all possible existing copies of the initial SCAO are actually deleted. However, in case that the user may keep his first terminal 4 as a replacement in case of any problems with the second terminal 6, the user has to re-migrate the SCAO.

FIG. 5 displays an embodiment of the present invention of a combined re-issuance and transcription procedure of a SCAO. The depicted embodiment represents a kind of combination of the methods of FIGS. 3 and 4 wherein the method of FIG. 4 is used to provide a copy of an initial SCAO to a back up server 12 via a game server 16. In FIG. 5 it is expected that a user has an account at the game server comprising e.g. a username and a password. The steps 22,24,25 to 26 have already been disclosed in FIG. 3.

In a subsequent step the user uses the second terminal 6 to log in 52 at the game server 16. The login procedure comprises the transmission of the username and password pair and the device identification of the second device. The game server 16 can recognize through the device identification that the device has changed and that a previously received initial SCAO can not be used on the second device 6 for executing any content.

The game server sends 53 the login data or the device identification of the first terminal 4 and of the second terminal 6 to the enhanced backup server 18. The enhanced backup server 18 combines the capability of the backup server 12 of FIGS. 2 and 3 to externally store initial specifically coded access objects (SCAOs) and the capability of the DRM server 14 of FIG. 4 to decode initial SCAOs and re-code secondary SCAOs.

The enhances backup server 18 can access a stored initial SCAO coded according to the first terminal device 4 and is capable of decoding it to an un-coded access object. The enhances backup server 18 can re-code said un-coded access object coded according to the identification data of the second terminal device 6 to a secondary SCAO. This enhanced backup server 18 stores the newly generated secondary SCAO in combination with the device identification data of the second device 6.

This newly generated secondary SCAO is then transmitted 54 to the game server 16. The game server then sends 56 the secondary SCAO to the second terminal device 6 via said cellular network 10.

That is, in FIG. 5 it is only necessary to log in with a new terminal to the game server to obtain a secondary SCAO for a new device.

FIG. 6 depicts another implementation of a method to re-issue SCAOs to another terminal device. The initial steps of acquiring a SCAO are the same as in disclosed in the FIGS. 1 to 5. In FIG. 7 a backup of the SCAO is stored in a backup server of a first terminal 4 e.g. in form of a private backup (not depicted). It is expected that the first terminal device 4 is destroyed in at the point of time the line of the first terminal gets interrupted. With the destruction of the first terminal device the user wants to execute or use the content on another (second) terminal device 6 he has obtained (indicated by the transition of the interrupted line to a continuous line). Due to the specificity of the SCAO it is not possible to use SCAOs that have been stored on an interchangeable memory module that has not been destroyed in the second terminal device 6.

Thus the user carries 100 his broken device and the available backups of the initial SCAOs on backup media like memory card and/or floppy disk to a service point 15. An operator of the service point 15 does establish access to the care server 13 and transfers an identification (e.g. the IMEI) of the broken first device 4 to the care server 13.

The software in the care server 13 requests 104 (based on IMEI (of the broken first terminal 4)) all stored data from the central server 17. The central server 17 forwards 106 all required data to the care server 13.

In a next step the care server 13 requests 108,110 (based on IMEI and/or a certification e.g. a private device key of the broken first terminal 4) all stored initial specifically coded access objects (SCAOs) on the backup server 12. The care server 13 requests the operator at the service point 15 to copy 112, 113 all data of the private backups like memory card and floppy disks to the care server 13.

The care server 13 decrypts or decodes all data (i.e. the initial SCAOs) from backup server 12 and forwarded private backup 112,113 data to identify the un-coded access objects of the user that allocated to the broken first terminal 4. The decryption can be done because the central server 17 has forwarded the private key of the broken first terminal 4 to the care server 13.

It is also envisaged that the care server 13 transfers all data to the central server for decryption or decoding of all data (i.e. the initial SCAOs) from backup server 12 and forwarded private backup 112,113 data to identify the un-coded access objects of the user that are allocated to the broken first terminal 4 in the protected central server 17. The decryption can be done in the central server 17 because the care server 13 has forwarded the SCAOs of the broken first terminal 4 to the central server 17.

It is also envisaged that the care server 13 transfers all data to the central server 17 for decryption or decoding of all data and the private backup 112,113 data to identify the un-coded access objects of the user that are allocated to the broken first terminal 4. The central server 17 may accesses the (i.e. the initial) SCAOs of the broken device directly from backup server 12. All decoding may be done in the protected central server 17, and no private key has to be transferred from the protected central server 17. The central server 17 then re-codes the (secondary) SCAOs according to the pubic key of the second device and may transfer it to the backup server 12 directly, to the second terminal or to the care server 13.

The care server 13 may send a notification to the operator of the service point via a window on a display of the service point 15 about all available initial SCAO of the user (just for information) (not depicted).

Subsequently to the identification of all initial SCAO of the broken first terminal 4 by the care server 13 a request is sent to the operator of the service point 15 to transfer 114 the IMEI number of the new second terminal 6 (e.g. by typing the new IMEI of second device in.) The IMEI of the second device is linked with a new private/public terminal device key.

On the basis of the new IMEI number of the second terminal 6 the information stored in the backup server is updated 116. The updating procedure comprises specifically encrypting of the un-coded access objects again with the new public key related to the second terminal device 6. This encryption results in secondary SCAOs (i.e. SCAOs for the second device).

The newly encrypted secondary SCAOs are to be forwarded 116 to the Backup server (eventually in combination with the old username, old password, new IMEI and may be encrypted with the new public device key).

The operator of the service point 15 will be requested to insert 118 the SIM card (subscriber identity member) of the user into the second terminal device 6.

Finally the user has to login with the second terminal device 6 to the backup server 12 (the user may get assistance from the operator). In detail a user establishes 120 an online connection via the cellular communication network 10 to backup server 12 and registers (i.e. logs in) with username password. By selecting a backup menu (in a background process) the IMEI and/or the public device key or certificate can be requested and transferred to the backup server 12. Finally the encrypted secondary specifically coded access objects (SCAOs) are downloaded 122 to the second terminal device 6. And the download of the secondary SCAOs is finalized.

In a last step (not depicted) the contents (e.g. corresponding game titles) for which execution of said secondary SCAOs is required can be transferred and installed in the second terminal 6.

FIG. 7 shows one embodiment of a network server for reissuing and/or transcribing of SCAOs. The network server is embodied as a backup server 12 for re-dispatching SCAOs from said server to a mobile terminal device via a cellular communication network 10.

The backup server 12 comprises a cellular communication network interface 60 for exchanging data via said cellular communication network with terminal devices (not depicted). The backup server 12 can receive terminal device identification, initial SCAOs and authentication data via said interface 60. Said interface 60 is further configured to send via said cellular communication network 10 obtained secondary SCAO to a terminal device with the terminal device identification said secondary SCAO has been obtained for. The SCAOs, the device identifications, the private device keys or the un-coded access objects may be transmitted via a secure memory card or online via GPRS connection. Thus the interface device has to comprise e.g. GPRS capabilities.

The terminal device further comprises an authentication means 76 connected to said interface for authenticating received terminal device identification and/or authentication data. The authentication means 76 is connected to at least a terminal identification storage 80 and a code identification storage 82 to be able to perform authentication procedures. The authentication means 76 is configured to determine if a received identification or authentication identifies a terminal identification as being related to a terminal for which an initial specifically coded access object (SCAO) has previously been generated.

The backup server 12 is further provided with a SCAO storage 84 for storing initial SCAOs and/or secondary SCAOs. The SCAO storage 84 can store initial SCAOs e.g. for determining if a SCAO has been already generated for a certain device or not. The SCAO storage 84 can also be used to store secondary SCAOs that have been generated (in this case the difference between of secondary and primary SCAOs becomes blurred).

The backup server is further provided with an obtaining means 78 configured for obtaining SCAOs. The obtaining means 78 is connected to said authentication means, for generating secondary SCAOs, according to device identifications. The generation may be performed as indicated in the preceding specification. Said obtaining means 78 is configured to obtain secondary SCAOs according to a received device identification and authentication data. The obtaining means may be able to rely on other external databases to obtain SCAOs by retrieving operations and/or by generation operations.

With this invention the owner of SCAOs (e.g. SCAOs of a game) will be able to have an automatic backup of his SCAOs during download of bought SCAOs. The saved SCAOs (backup) can be downloaded at any time from the owner. Misuse of the backup is quite unlikely due to the strong encryption of the SCAOs on the backup server.

With this invention the owner of SCAOs (e.g. an access object of a computer or online game) will be able to regain his SCAOs in the case of a broken device. The saved SCAOs (backup) can be downloaded at any time from the owner. Misuse of the backup is quite unlikely due to the strong and specific encryption of the SCAOs on the backup server.

This application contains the description of implementations and embodiments of the present invention with the help of examples. A person skilled in the art will appreciate that the present invention is not restricted to details of the embodiments presented above and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method for re-dispatching a specifically coded access object from a server to a terminal device via a communication network, comprising:
receiving at a server at least one terminal device identification and/or authentication data;
determining if said identification and/or authentication data identifies a terminal identification as being related to a terminal for which an initial specifically coded access object has previously been generated,
obtaining at said server a secondary specifically coded access object according to a received terminal identification if a received terminal identification has been identified as a terminal for which an initial specifically coded access object has previously been generated, and
sending said secondary specifically coded access object to said terminal device via said network, said terminal device having a terminal device identification for which said secondary specifically coded access object has been obtained.

2. Method according to claim 1, further comprising storing said initial specifically coded access object in a preceding step at said server.

3. Method according to claim 2, wherein said initial specifically coded access object is stored after an initial generation of said initial specifically coded access object.

4. Method according to claim 2, wherein said initial specifically coded access object is stored after a reception of said initial specifically coded access object from a terminal device during an online access.

5. Method according to claim 2, wherein said step of obtaining at said server said secondary specifically coded access object is performed by retrieving said previously stored initial specifically coded access object.

6. Method according to claim 2, wherein two terminal device identifications are received, namely a first device identification and a second device identification, and wherein said step of obtaining at said server a specifically coded access object is performed by decoding said previously stored first specifically coded access object according to said first received device identification and generating said secondary specifically coded access object for transmission according to said second received device identification.

7. Method according to claim 1, wherein two terminal device identifications are received, namely a first device identification and a second device identification and wherein further an initial specifically coded access object is received at said server, said specifically coded access object being coded according to said first device identification, and
wherein said step of obtaining at said server said secondary specifically coded access object is performed by decoding said received initial specifically coded access object according to said first received device identification and generating said secondary specifically coded access object for transmission according to said second received device identification.

8. Method for re-dispatching a specifically coded access object from a server to a terminal device in a system comprising a terminal and a server connected via a communication network comprising:
sending from said terminal device at least one terminal device identification to said server,
sending authentication data to said server,
receiving at said server said at least one terminal device identification and said authentication data,
determining if said identification or authentication data, identifies a received terminal identification as being related to a terminal for which an initial specifically coded access object has previously been generated,
obtaining at said server a secondary specifically coded access object according to a received device identification and authentication data, if a terminal identification has been identified said terminal being identified as a terminal for which an initial specifically coded access object has previously been generated,
sending said secondary specifically coded access object to said terminal device , via said communication network, said terminal device having the terminal device identification said secondary specifically coded access object has been obtained for, and
storing said secondary specifically coded access object in said terminal device.

9. Method according to claim 8, further comprising storing said initial specifically coded access object on a user memory device operatively connected to said terminal device.

10. Method according to claim 9, further comprising storing an identification of said terminal together with said initial specifically coded access object on said user memory device.

11. Method according to claim 8, wherein said communication network is a cellular communication network and said terminal device is a mobile cellular terminal of said cellular communication network.

12. Computer program product capable to re-dispatching a specifically coded access object from a server to a terminal device, comprising program code sections for carrying out the steps of claim 1, when said program is run on a controller, processor-based device, a computer, a microprocessor based device, a terminal, a network device, a terminal, a mobile terminal or a mobile communication enabled terminal.

13. Computer program product for executing a method capable to re-dispatching a specifically coded access object from a server to a terminal device, comprising program code sections stored on a machine-readable medium for carrying out the steps of claim 1, when said program product is run on a controller, processor-based device, a computer, a microprocessor based device, a terminal, a network device, a terminal, a mobile terminal, or a mobile communication enabled terminal.

14. Software tool capable to re-dispatching a specifically coded access object from a server to a terminal device, comprising program portions for carrying out the operations of claim 1, when said program is implemented in a computer program for being executed on a controller, processor-based device, a microprocessor based device, processing device, a terminal device, a network device, a terminal, a mobile terminal, or a mobile communication enabled terminal.

15. Computer data signal embodied in a carrier wave and representing instructions, which when executed by a processor cause the steps of claim 1 to be carried out.

16. Network server for re-dispatching a specifically coded access object from a server to a terminal device via a communication network comprising:
an interface to said communication network for receiving at least one terminal device identification, an initial specifically coded access object and authentication data,
an authentication means connected to said interface for authenticating received terminal device identification and/or authentication data;
a secondary specifically coded access object obtaining means connected to said authentication means, for generating a secondary specifically coded access object,
at least one storage connected to said authentication means,
wherein said authentication means is configured to determine if said identification or authentication, identifies a terminal identification as being related to a terminal for which an initial specifically coded access object has previously been generated,
wherein said obtaining means is configured to obtain secondary specifically coded access objects according to received device identification and authentication data,
wherein said storage is configured for storing specifically coded access objects , and
wherein said interface is configured to send said obtained secondary specifically coded access object to a terminal device with the terminal device identification for which said secondary specifically coded access object has been obtained, via said communication network.

17. Network server according to claim 16, wherein said network server is a server of a cellular communication network, and said interface is an interface to said cellular communication network configured for receiving at least one terminal device identification of a mobile cellular terminal device.
